(19) United States
(12) Patent Application Publication
(10) Pub. No.: US 2026/0220610 A1
(43) Pub. Date: Jul. 30, 2026

(54) RECRUITING PLATFORM WITH GENERATIVE PROFILE CREATION AND AUTOMATED COMMUNICATION

(71) Applicant: Athlete Narrative Inc., Boise, ID (US)

(72) Inventors: Matthew R. Carter, Boise, ID (US); Drisan B. James, Star, ID (US); Andrew T. Fullmer, Eagle, ID (US); David A. Hitz, Meridian, ID (US)

(21) Appl. No.: 19/462,828

(22) Filed: Jan. 28, 2026

Related U.S. Application Data
(60) Provisional application No. 63/750,762, filed on Jan. 28, 2025.

(51) Int. Cl. G06Q 10/1053; G06Q 10/107

(52) U.S. Cl. CPC G06Q 10/1053; G06Q 10/107

(57) ABSTRACT

Techniques for a recruiting platform are disclosed. The recruiting platform supports generative profile creation and automated communications. A user accesses the platform to complete an information-gathering questionnaire. The platform uses the received information to generate an athlete profile stored as a structured dataset. The platform stores structured recruiting target profiles for coaches, teams, or institutions. The user selects one or more recruiting targets or recruiting target attributes and/or selects information from their athlete profile. Athlete profile information and recruiting target profile(s) are provided as input to an AI module to generate recommendations and/or structured text targeted to the recruiting target(s). The structured text is transmitted via a native email application on the user's device. The platform collects interaction metadata associated with the structured text, generates a recommended action based on the interaction metadata, and outputs the recommended action to the user's device.

### CROSS-REFERENCE TO RELATED APPLICATION

This application claims the benefit of U.S. Provisional Patent Application 63/750,762, filed Jan. 28, 2025, which is hereby incorporated by reference.

### TECHNICAL FIELD

The present disclosure generally relates to recruiting platforms, automated entity profile generation, and automated messaging for entities such as recruiters, prospects, and related entities.

### BACKGROUND

Traditional recruiting, such as the recruitment of high school athletes by college coaches, has historically relied on fragmented and opaque processes. Coaches typically receive large volumes of athlete information in the form of highlight videos, statistics, scouting reports, emails, and third-party recruiting profiles. These materials are often delivered through multiple channels and formats, making it difficult for coaches to efficiently review, compare, and contextualize athletes. As a result, many athletes, particularly those without access to elite programs, showcases, or established recruiting networks, struggle to gain visibility, even when they possess the skill set or potential to succeed at the collegiate level.

From the athlete's perspective, the recruiting process is equally challenging. High school athletes are often expected to proactively contact dozens or even hundreds of college programs, making it difficult to keep track of communication statuses. Prospects are expected to tailor communications with different coaching staff members while simultaneously managing academic, athletic, and personal obligations. Responses from coaches may be limited, delayed, or nonexistent, leaving athletes uncertain about their standing or next steps. This asymmetry makes it difficult for athletes to understand which programs are genuinely interested, which criteria are most important to specific coaches, and how to prioritize their outreach efforts. Researching different athletic programs and generating focused materials and messages to provide to different coaches based on the coaches'differing needs is extremely time-consuming.

Coaches, in turn, face significant challenges in identifying athletes who are not only talented, but also a strong fit for their specific program needs, playing style, academic standards, team culture, and roster constraints. Evaluating fit may require raw performance metrics, assessment of development trajectory, positional needs, personality, work ethic, long-term potential, and character. Coaches who are constrained by time and resource limitations may rely heavily on familiar, already in-place pipelines, recommendations from personal contacts, or information from high-profile events. Reliance on such traditional recruiting channels can inadvertently introduce bias and exclude qualified athletes who fall outside these recruiting channels. Rating and communicating with prospects are also extremely time consuming.

Additionally, athletes and their parents are often left out of key stages of the decision-making process. Communication gaps, unclear timelines, and informal or unwritten evaluation criteria can create confusion and anxiety, particularly when offers, visits, or roster decisions are being considered. Parents may have limited insight into how decisions are made or why certain opportunities materialize while others do not. Likewise, coaches may be left out of key stages of the selection process by prospective athletes. Together, these challenges highlight systemic inefficiencies and transparency issues in traditional recruiting, contributing to missed opportunities for athletes and suboptimal matching between athletes and collegiate programs.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The implementations are illustrated by way of example and not by way of limitation in the figures of the accompanying drawings. It should be noted that references to “an” or “one” implementation in this disclosure are not necessarily to the same implementation, and they mean at least one. In the drawings, in accordance with one or more implementations:

FIGS. 1A-B illustrate a diagram of a recruiting platform with generative profile creation and automated communication;

FIG. 2 illustrates a recruiting platform system;

FIG. 3 illustrates a set of operations for generative profile creation and automated communication;

FIGS. 4A-B illustrate example graphical user interfaces for a profile module of an application associated with the platform;

FIGS. 5A-F illustrate example graphical user interfaces for a content module of an application associated with the platform;

FIGS. 6A-C illustrate example graphical user interfaces for displaying and receiving target and target attribute selection for an application associated with the platform;

FIG. 7 illustrates an example graphical user interface for an onboarding and introductory workflow of an application associated with the platform; and

FIG. 8 illustrates a block diagram of a computing system.

### DETAILED DESCRIPTION

One or more implementations include a method including: storing an athlete profile for a user as a structured dataset in an athlete profile database; storing a set of recruiting target profiles for a set of recruiting targets as structured datasets in a recruiting target profile database; receiving, over a network, from a user application executing on a client device, a selection of (i) at least one of a recruiting target or a recruiting target attribute and (ii) at least one profile category including profile information to be shared with a recruiting target of the set of recruiting targets; providing, as input data to a language model, (i) at least a subset of the athlete profile selected based on the at least one profile category, (ii) at least a subset of a recruiting target profile for a recruiting target of the set of recruiting targets, and (iii) a language model prompt that causes the language model to generate structured text targeted to the recruiting target, wherein the structured text includes a hyperlink that enables trackable interactions; causing a native email application of the client device, separate from the user application, to generate an email message including the structured text; receiving, from a tracking server, interaction metadata describing an interaction with the hyperlink; providing at least the interaction metadata and the athlete profile to an artificial intelligence (AI) agent configured to generate a recommended action for presentation in the user application; and outputting, over the network to the client device, the recommended action.

One or more implementations include one or more non-transitory computer readable media including instructions. The instructions cause performance of the method when executed by one or more hardware processors. One or more implementations include a system having one or more hardware processors; an athlete profile database; a recruiting target profile database; a language model; a tracking server; a network; an artificial intelligence (AI) agent configured to generate a recommended action for presentation in a user application executing on a client device; and one or more non-transitory computer readable media configured to execute instructions stored on the one or more non-transitory computer readable media which, when executed by the one or more hardware processors, cause the system to perform the method.

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. Wherever practicable, similar or like reference numbers may be used in the figures and may indicate similar or like functionality.

### 1. General Overview

In one or more implementations, a recruiting platform with generative profile creation and automated communication and content generation facilitates communication with recruiting targets (e.g., target entities such as coaches, teams, or schools), brand development, establishment of social presence, and, ultimately, recruitment for an athlete or other primary entity. Often, the exorbitant costs of marketing agencies, sports agents, social media managers, and the like make growing a professional career in sports cost-prohibitive for parents, children, and others who would like to develop a professional career in sports. One or more implementations address this problem by providing a content generation platform that helps athletes build their personal brand, communicate with coaches, or other decision-makers, and get recruited. In other contexts, the platform may also be used to help other primary entities, such as job applicants, performers, or content creators, to be recruited by target entities. For example, the platform may help hobbyists get recruited by recreational groups by automating communication to group leaders. The platform makes it easy for athletes or other recruitees to maximize their potential by getting recruited to the best possible team or group. The automated communications are scalable and are implemented using spam-safe engagement tracking that enables tracking interaction metadata for the communications without causing the communications to be filtered by email spam filters.

In one or more implementations, an onboarding process is performed in which an athlete (or other primary entity) inputs information into an online application or questionnaire. The questionnaire is used for information-gathering that helps identify a unique story or narrative for the athlete. The application automates tasks to help the athlete to develop interpersonal relationships more easily with prospective coaches, leaders, and programs via targeted outreach to colleges, schools, institutions, teams, and/or other target entities. In some implementations, the application automates tasks to help the athlete build a presence on social media platforms.

One or more implementations use a schema and/or scoring system for athlete profiles and/or recruiting target profiles that are optimized to improve efficiency and reduce latency. For example, the platform may automate construction of a structured persistent profile page for the athlete, which may be referred to as a “radar page.” The radar page may include elements such as a resume, a brag sheet, athletic performance statistics, and/or a highlight reel. The radar page simplifies and streamlines publicity and availability of information about the athlete and is used to generate communications to coaches.

One or more implementations use artificial intelligence (AI) and/or algorithm-based techniques to generate communications and/or other content based on the radar page. Such communications are forwarded via email to target entities (e.g., coaches and athletic programs), automatically and/or with athlete approval.

One or more implementations identify and/or aggregate relevant communications and/or other content and present the communications and/or content on a unified platform. A module for identifying and/or aggregating communications and/or content is referred to herein as “The Scout,” or as a scout module. The scout module retrieves pertinent content for an athlete to engage with based on the athlete's goals and on generating targeted outreach to target coaches or other target entities. In this way, the platform provides a system that helps athletes stand out and get recruited. Additionally, athlete users may share their social media content along with their teammates'social media content to facilitate marketing, such that local businesses or other potential sponsors are more likely to sponsor the athlete or their team.

One or more implementations allow an athlete to select one or more schools, athletic programs, or other institutions for targeted outreach for recruiting purposes. A module that facilitates selection of targets and/or target attributes is referred to herein as “The Recruiter,” or as a recruiter module. The recruiter module allows athletes to view information about potential target entities (e.g., athletic programs) and to choose whether the potential target entities are selected as targets. For example, an athlete may select whether certain schools are a good fit based on information about the schools. In some implementations, users may view information regarding teams and athletic programs, including social media profiles for the programs, that are made available through a database accessible by the platform.

By way of example, when an athlete using the platform selects a coach or athletic director to email, a native platform (e.g., a native operating system) of the user device (e.g., a mobile device or computer) opens a native application (e.g., a native email or social media application) that is set as default. Various implementations generate a targeted email, which may be personalized to a target coach, using information from the athlete's radar page and information about the coach as input data (e.g., control input and/or context) that is provided to a language model to generate the targeted email. The athlete uses such emails to automate personalized outreach to multiple coaches. The outreach is personalized at scale to any number of recruiting targets while maintaining authenticity to the athlete's unique identity and narrative by leveraging machine learning and natural language processing to generate contextually aware content that reflects athletes'narrative, archetypes, accomplishments, and/or personal stories.

One or more implementations track the number of emails that are sent out and monitor the emails for measurable feedback. When a coach that receives an email interacts with the email, the interaction is tracked. Methods of tracking interactions may include using a tracking hyperlink in the body of the email or a tracking pixel included in the transmission when the email is sent. When the email is viewed and/or the hyperlink is clicked, the platform measures and records feedback. One or more implementations use the measured feedback to adjust one or more prompts and/or contexts used as input into an AI agent for generating recommended actions and/or subsequent content. In this way, feedback is used to improve recommended actions, generated structured text for communications (e.g., emails to target entities) and/or other generated content (e.g., social media content).

By storing athlete profiles and recruiting target profiles as structured datasets and selectively reusing relevant subsets of profile data across multiple communications, the platform reduces redundant data entry, improves the computational efficiency of content generation, and reduces network traffic associated with repeated profile transmission. Feedback-driven adjustment of content generation based on interaction metadata further reduces computational resource consumption by suppressing redundant communications and excluding recruiting targets that have already been contacted or engaged, without requiring retraining of the underlying model. In addition, invoking native communication applications on client devices, rather than transmitting communications directly from the platform, improves deliverability and reliability while minimizing server-side message handling and reducing exposure to spam filtering mechanisms. Together, these techniques improve the efficiency, scalability, and reliability of automated communication.

### Example Implementation

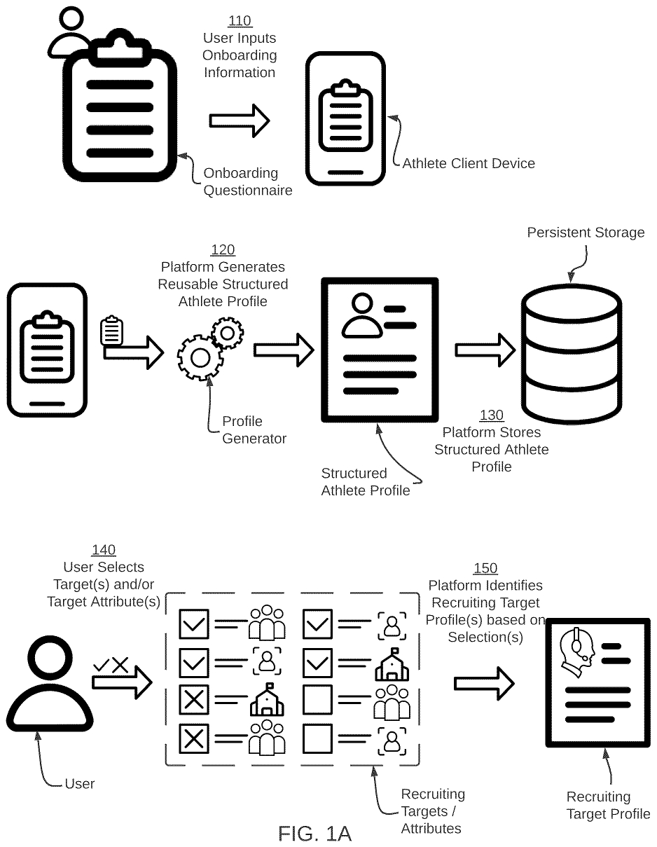

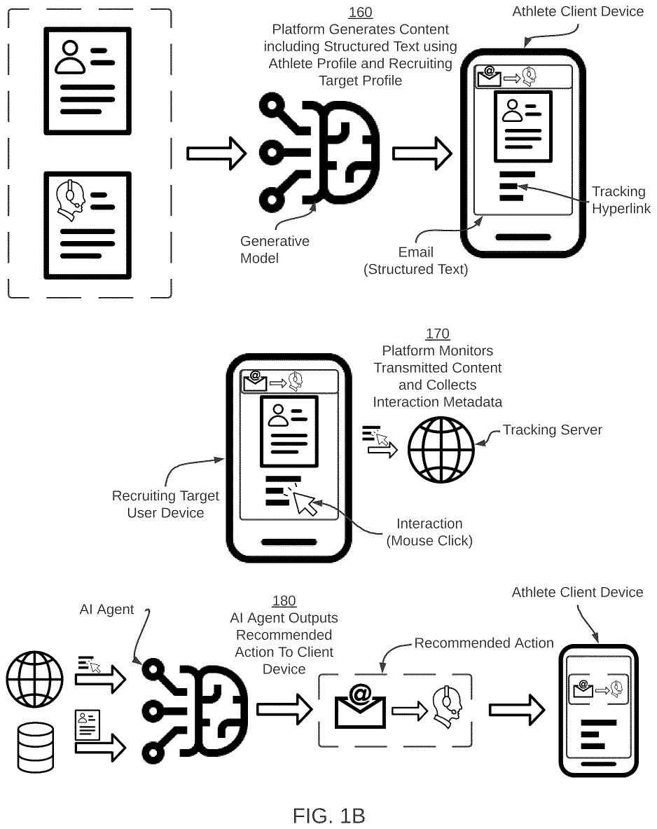

FIGS. 1A-1B illustrate an example implementation of a recruiting platform that supports structured profile creation and automated generation of targeted communications. As shown in FIG. 1A, and by reference number 110, a user inputs onboarding information to the platform via a client device. For example, an athlete completes a quiz or questionnaire via a user interface of a website or mobile application accessed via a smartphone or computer. The onboarding information is collected using form fields, questionnaires, or similar mechanisms and includes information such as personal information, contact information, athletic information, academic information, a sport played by the athlete, a position, an athletic statistic, a grade point average, historical athletic performance information, a highlight video clip, a list of completed coursework, and/or other related data. The onboarding information may be updated over time as the athlete edits the information or adds additional media. In one or more implementations, at least a portion of the onboarding process is monitored by the platform to evaluate completeness.

As shown in FIG. 1A, and by reference number 120, the platform generates a reusable structured athlete profile based on the onboarding information. For example, a profile generator generates an athlete profile that is stored as a structured dataset in an athlete profile database. The athlete profile includes normalized fields such as name, contact information, sport, academic attributes, performance attributes, narrative text, summaries, and/or links to media.

As shown in FIG. 1A, and by reference number 130, the platform stores the structured athlete profile in persistent data storage. The structured athlete profile is reusable for generating structured text and/or other content. In one or more implementations, this structured athlete profile is referred to as a radar page. The radar page includes: (a) customizable athletic performance metrics with user-defined categories and values; (b) academic credentials including standardized test scores and grade point average (GPA); (c) a multi-media showcase including profile imagery, highlight videos, and/or embedded social media posts; (d) narrative elements such as personal motivational quotes and accomplishments; (e) a verified reference network with coach and/or mentor contact information; and/or (f) integration links to other, secondary recruiting platforms [e.g., next college student athlete (NCSA), Hudl, Perfect Game, etc.].

As shown in FIG. 1A, and by reference number 140, the user selects one or more targets and/or target attributes. The platform receives, from an athlete, a selection of at least one of a target coach, target, team, target school, target institution, target athletic division, target geographic state, other target location, scholarship availability, or another attribute associated with a coach, team, or institution.

As shown in FIG. 1A, and by reference number 150, the platform identifies one or more recruiting target profiles based on the selections. For example, the platform stores recruiting target profiles for a set of recruiting targets as structured datasets in a recruiting target profile database. The platform inputs the athlete's structured profile, the selection(s), and the recruiting target profiles into a recommendation model to cause the recommendation model to output one or more selected recruiting targets. Optionally or alternatively, the platform filters recruiting target profiles based on the selection(s) without using a recommendation model.

As shown in FIG. 1B, and by reference number 160, the platform generates content including structured text using the athlete profile and the recruiting target profile. In one or more implementations, the platform provides, as input to a language model, (i) at least a subset of the athlete profile, (ii) at least a subset of a recruiting target profile for a recruiting target, and/or (iii) a language model prompt. In some implementations, the platform receives a selection of at least one athlete profile item and/or profile category selected by the athlete to be shared with a recruiting target. The platform provides the selected item or category an input into the language model to determine a subset of the athlete profile to include in the generated content. For example, the language model generates an email body that includes structured text targeted to a coach and content selected from the athlete's profile.

In some implementations, the generated content includes a tracking hyperlink in the structured text, or another tracking mechanism, for tracking interactions with the content. A server configured for detecting interaction monitors the content to track interaction. For example, the language model generates an email body that includes a tracking hyperlink that is sent to a recruiting target from the athlete. The platform sends the email by interacting with the operating system of the athlete's client device to open a native email application, separate from the user application, that is used to send the email. The platform populates content fields of the native email application and launches the email application so that the athlete may review and transmit the email from their personal email account.

As shown in FIG. 1B, and by reference number 170, the platform monitors the transmitted content and collects interaction metadata. In various implementations, interaction metadata is automatically recorded based on detecting interaction with one or more tracking artifacts (e.g., a hyperlink or tracking pixel). For example, the platform receives, from a tracking server, interaction metadata describing a click on a tracking hyperlink included with the content. Examples of interaction metadata include a click event, a link activation event, or another machine-detectable interaction metric.

As shown in FIG. 1B, and by reference number 180, the platform uses an AI agent to output a recommended action to the athlete's client device. In one or more implementations, the AI agent is configured to generate a recommendation based on the interaction metadata. For example, the AI agent recommends one or more same and/or different recruiting targets and/or subsequent content to be sent to the recruiting target(s). The recommended action is output, over a network, to the athlete's client device and is presented to the athlete via the user application.

In some implementations, the platform generates an adapted recommendation and/or subsequent communication by using the interaction metadata as feedback to update a prompt or context and/or to apply exclusion logic. For example, the platform excludes a recruiting target from outreach if the recruiting target has already been sent an email within seven days (or a greater or fewer number of days). The platform may recommend a different recruiting target that has not been sent an email within seven days, and/or may modify content of a subsequent communication to a recruiting target. In some cases, the exclusion logic prevents the platform from sending more than one email to a recruiting target within seven days unless the recruiting target has interacted with a tracking hyperlink. In this way, engagement data is used to optimize recommended actions and/or subsequent communications while reducing redundant outreach.

### 2. Recruiting Platform System

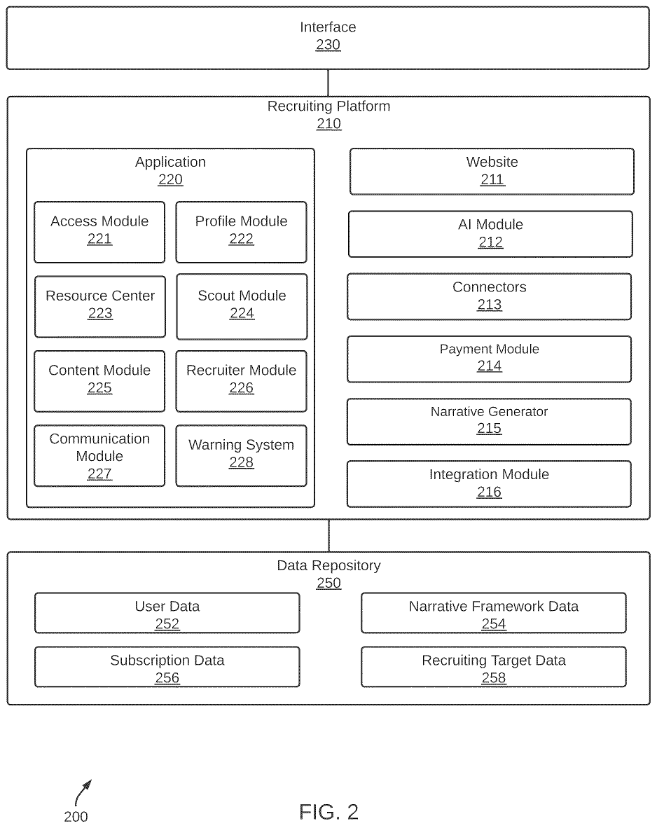

FIG. 2 illustrates a recruiting platform system 200, in accordance with one or more embodiments. As illustrated in FIG. 2, the recruiting platform system 200 includes a recruiting platform 210, an interface 230, and a data repository 250.

In FIG. 2, the recruiting platform 210 includes a website 211, an AI module 212, connectors 213, a payment module 214, a narrative generator 215, an integration module 216, and an application 220. The illustrated components represent logical and functional components of the recruiting platform 210 and are not intended to require a particular physical or software architecture. In one or more implementations, components may be combined, subdivided, distributed across multiple computing systems, implemented using cloud-based, remote, or third-party services, coupled via a network, or a combination thereof.

The website 211 provides a user-facing interface through which users access the recruiting platform 210. In one or more implementations, the website 211 includes onboarding workflows, account management, informational content, and/or subscription functionality. The website 211 presents onboarding questionnaires used to collect persistently stored information. The website 211 communicates with backend components of the platform via an application programming interface (API) and is accessible via a browser executing on a client device.

The AI module 212 includes one or more AI agents, language models, or other generative models, as well as associated processing logic. In one or more implementations, an AI agent includes one or more language models and may include third-party language model services and/or models native to the platform. In one or more implementations, the AI module 212 receives athlete profile data, recruiting target information, and/or prompts and generates recommendations, structured text for targeted communications, and/or other content.

For example, the AI module 212 includes a large language model (LLM) that performs functions in response to function calls and/or that performs inferencing in response to prompts input into the LLM. In this example, the LLM identifies recommended recruiting targets using a rule-based scoring system that generates scores used to rank and/or identify the recruiting targets based on fields of an athlete profile, athlete outreach history (e.g., previous emails), engagement history (e.g., interaction metadata), and/or recruiting target attributes. The LLM uses a targeted filtering and scoring system to quickly output high-quality recommendations based on the structured profile data and outreach history.

One or more implementations of the AI module 212 include an agentic AI assistant. The AI assistant is accessible via the application 220 to receive user input and provide responses that are presented to the user in the application 220. For example, an athlete uses a chat interface of the application 220 to have a conversation with the AI assistant by inputting prompts and/or other input into the AI assistant to receive recommendations from the AI assistant. The AI assistant makes recommendations, such as by recommending recruiting targets to the athlete, based at least in part on the conversation between the athlete and the AI assistant, the athlete's profile, the athlete's outreach history, and/or a recruiting target profile. Depending on the implementation, an AI assistant may be included in the application 220, may be hosted separately from the application 220 on the platform 210 and/or may be hosted by a third party and accessible to the platform 210 via the interface 230.

The connectors 213 include one or more integration services or APIs configured to transport data between components of the recruiting platform 210 and external systems. In one or more implementations, the connectors 213 facilitate data exchange among onboarding tools, databases, customer relationship management (CRM) systems, payment processors, AI services, and/or external applications.

The payment module 214 manages subscriptions, billing, and payment processing for the recruiting platform 210. In some implementations, the payment module 214 integrates with a third-party payment processor to manage subscription plans, billing cycles, and payment status. Subscription information may be used to enable or restrict access to platform features.

The narrative generator 215 is configured to generate and/or maintain a narrative associated with an athlete. In one or more implementations, the narrative generator 215 analyzes onboarding information to determine narrative characteristics. In some implementations, the narrative generator 215 defines one or more constraints used to promote consistency across generated communications. The narrative generator 215 operates in conjunction with the AI module 212 to guide or constrain generated outputs by the AI module. Optionally, the platform may provide warnings when edits to structured text by an athlete cause content to violate a constraint or otherwise deviate from a defined narrative.

The integration module 216 is configured to coordinate interactions among internal components of the recruiting platform 210 and/or external systems. In one or more implementations, the integration module 216 interfaces with an operating system of a client device to integrate a native email application with the AI module 212, allowing AI-generated content to populate fields of email messages within the native email application. In an implementation, the platform does not transmit the email directly but instead invokes the native email application so that the email is sent from the athlete's personal email address.

As shown in FIG. 2, the application 220 provides an environment, such as a mobile application, local application, or web application, by which an athlete or other user interacts with the recruiting platform 210. As shown, the application includes an access module 221, a profile module 222, a resource center 223, a scout module 224, a content module 225, a recruiter module 226, a communication module 227, and a warning system 228.

The access module 221 is configured to perform authentication, authorization, and/or session management within the application 220. In one or more implementations, the access module 221 enforces role-based access controls and manages secure session persistence.

The profile module 222 is configured to present and manage structured athlete profiles within the application 220. In one or more implementations, the profile module 222 renders, from a persistent backend storage, a profile page including personal information, athletic data, academic data, and associated media. Updates made via the profile module 222 are synchronized with the persistent backend storage.

The resource center 223 provides informational and educational content accessible through the application 220. In one or more implementations, the resource center 223 includes articles, guides, videos, and other materials related to recruiting and/or brand development. The resource center 223 may also provide help documentation, frequently asked questions, and support resources to assist users in understanding and using the platform's features.

The scout module 224 is configured to assist users in discovering and engaging with external content and opportunities relevant to their goals. In one or more implementations, the scout module 224 identifies coaches, programs, teams, or other recruiting targets, matching attributes selected by an athlete and provides detailed information about the recruiting targets. The scout module 224 filters and/or prioritizes target profiles based on athlete's target or target attribute selections and/or stored target profile information.

The content module 225 is configured to generate and/or present generated content and/or tasks to the user. In one or more implementations, the content module 225 displays generated targeted email drafts, draft social media post content, and/or other generated content items. The content module 225 allows users to review, edit, and/or approve content prior to publication or transmission. In some implementations, the content module 225 organizes generated content as a scheduled task and/or as an approvable task in a task-based workflow system within the application 220 that tracks completion, approval status, and/or received feedback for tasks.

In some implementations the content module 225 performs engagement tracking to generate engagement data by recording interaction data and/or interaction metadata associated with transmitted content. The engagement data is included in a prompt or context provided to the AI module 212 and is used as context to guide recommended actions and/or content output by the AI module. For example, the engagement data is used to avoid duplicate communication with a recruiting target, to alter the tone of a recommendation based on previous outreach volume, and/or to provide analytics regarding previous outreach based on tracking a number of hyperlink clicks and/or a sent email history.

The recruiter module 226 is configured to support targeted recruiting outreach from within the application 220. In one or more implementations, the recruiter module 226 includes a list of schools, programs, and/or coaches and information about the schools, programs, and/or coaches. The recruiter module 226 includes a selector by which an athlete can select recruiting targets or recruiting target attributes. The recruiter module 226 coordinates with backend systems to match user-selected attributes with target entities.

The communication module 227 is configured to facilitate transmission and tracking of communications initiated through the application 220. In one or more implementations, the communication module 227 interfaces with native communication channels such as email clients and/or social media platforms. In some implementations, the communication module 227 initiates automated generation of targeted emails and/or launches native communication clients (e.g., email applications on client devices) with pre-populated content generated based on the athlete's profile.

In one or more implementations, the communication module 227 embeds tracking artifacts in the content to facilitate collection of interaction metadata. For example, interaction with a tracking artifact triggers a monitoring server to record interaction data (e.g., an identification of the tracking artifact and the type of interactions) and/or interaction metadata (e.g., a time or location associated with the interaction). In some implementations, the communication module 227 aggregates information about sent communications and/or interaction data or metadata and presents the information to the user via a graphical user interface to provide communication analytics.

The warning system 228 is configured to generate notifications and alerts related to content integrity, compliance, and/or user actions. In one or more implementations, the warning system 228 alerts an athlete when generated content has been edited in a manner that violates or deviates from an established narrative for the athlete. The warning system 228 may also present confirmations or warnings prior to public posting or transmission, such as notifying the user that a communication will become public or irreversible once sent.

The interface 230 refers to hardware and/or software configured to facilitate communications between a user and/or operator and the recruiting platform 210. For example, the interface 230 may include components such as a network interface or input/output devices.

In one or more implementations, interface 230 includes software that renders user interface elements and receives input via user interface elements. In some implementations, the interface 230 includes a Wi-Fi, Bluetooth, or other wireless communication component that may be used to configure and/or update the recruiting platform 210.

Examples of interfaces include a graphical user interface (GUI), a command line interface (CLI), a haptic interface, and a voice command interface. These types of interfaces may be integrated directly via the recruiting platform 210 or may be accessible via a connected device (such as a mobile device or personal computer) executing an application with various user interface elements. Examples of user interface elements include checkboxes, radio buttons, dropdown lists, list boxes, buttons, toggles, text fields, date and time selectors, command lines, sliders, pages, and forms.

The data repository 250 is a storage structure accessible by the recruiting platform 210 and configured to store data associated with the recruiting platform system 200. In FIG. 2, the data repository 250 includes user data 252, narrative data 254, subscription data 256, and recruiting target data 258. The data repository 250 is implemented using one or more memory devices, such as non-volatile memory for persistent data and/or volatile memory and may be organized to support various data structures.

The user data 252 includes information associated with athletes or other users of the recruiting platform, such as information generated from onboarding questionnaires and other user-provided inputs. Example user data 252 includes profile attributes, athletic classifications, preferences, goals, performance metrics, media content (e.g., images or video clips), historical interaction data and/or metadata for the user, application settings, and user preferences. In some implementations, the user data 252 is used as input to derive an athlete narrative constraint, generate a radar page, and/or personalize structured text or other content generated by the platform.

The narrative data 254 includes data used to characterize or shape how content is generated on behalf of a user. In some implementations, the narrative data 254 includes archetype classifications, branding themes, stylistic parameters, personality indicators, development trajectories, and/or other narrative attributes derived from user data 252. The narrative data 254 may be generated automatically by the platform and used to constrain or guide generation of content to facilitate consistency.

The subscription data 256 includes information related to user identity and access management within the recruiting platform. Example subscription data 256 includes subscription tier information, billing status, feature entitlements, usage limits, and account status indicators. The subscription data 256 may be used by the platform to control availability of features.

The recruiting target data 258 includes information associated with recruiting target entities, such as coaches, athletic programs, teams, colleges, or universities. In some implementations, the recruiting target data 258 includes target attributes, program characteristics, contact information, and/or historical interaction data and/or metadata associated with the recruiting targets. The recruiting target data 258 may be populated from a platform-maintained database, third-party data sources, and/or user-provided inputs.

In one or more implementations, the data repository 250 is a storage unit and/or device (e.g., a file system, database, collection of tables, or any other storage mechanism) for storing data. Further, a data repository 250 may include multiple different storage units and/or devices. The multiple different storage units and/or devices may or may not be of the same type and may or may not be located at the same physical site. Further, a data repository 250 may be implemented or executed on the same computing system as and/or a different computing system from the recruiting platform 210. The data repository 250 may be communicatively coupled to the recruiting platform 210 via a direct connection or via a network.

Information describing the recruiting platform 210 may be implemented across any components within the recruiting platform system 200. However, this information is illustrated within the data repository 250 for purposes of clarity and explanation.

### 3. Operations for Generative Profile Creation and Automated Communication

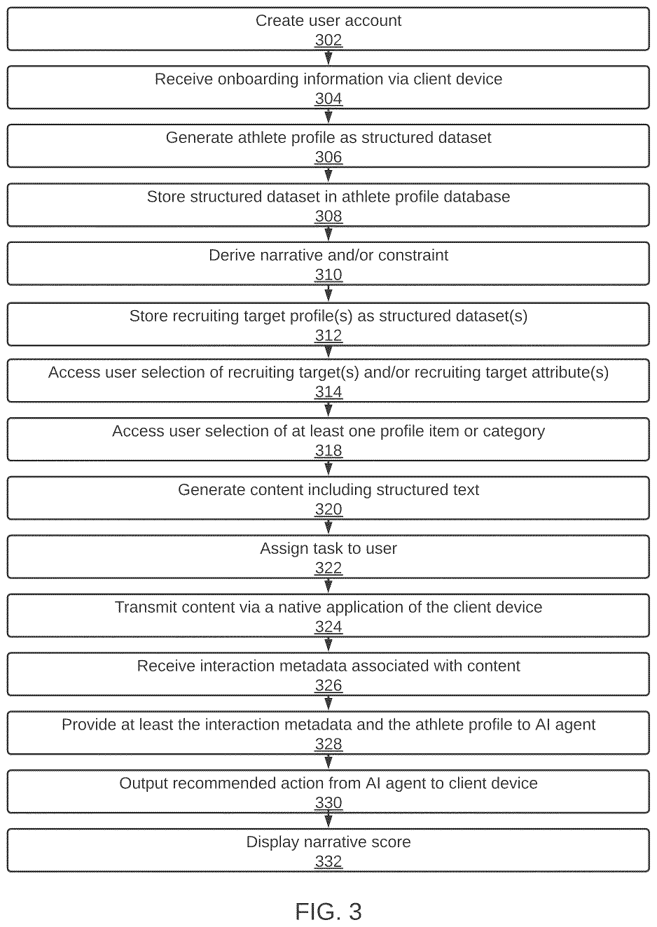

FIG. 3 illustrates a set of operations for generative profile creation and automated communication for a recruiting platform, in accordance with one or more implementations. Operations described with reference to FIG. 3 may be performed by a recruiting platform of a recruiting platform system, such as the recruiting platform 210 of the recruiting platform system 200 of FIG. 2. One or more operations illustrated in FIG. 3 may be modified, rearranged, or omitted altogether. Accordingly, the particular sequence of operations illustrated in FIG. 3 should not be construed as limiting the scope of implementations.

In an implementation, the recruiting platform creates a user account (Operation 302). For example, the recruiting platform creates a user account in response to a signup request received via a website, mobile application, or other client interface. Creating the user account includes generating a unique user identifier and storing authentication information and account metadata. The recruiting platform may verify user identity and/or obtain consent to applicable terms and conditions.

In some implementations, the recruiting platform generates an auxiliary account, such as for a parent or guardian, that is linked to the user account. The platform may provide information about the user account to an auxiliary account or auxiliary entity via an auxiliary communication. For example, the platform provides a summary of user account activity to the auxiliary account or makes a communication history and/or interaction data or metadata for the user account available to the auxiliary account.

The recruiting platform receives onboarding information via a client device (Operation 304). In one or more implementations, the recruiting platform presents onboarding interfaces that prompt the user to provide onboarding information including personal information, contact information, athletic data, academic data, media assets, goals, preferences, and/or narrative-related responses. The onboarding information may be received through forms, questionnaires, uploads, or integrations with third-party systems. In some implementations, the platform extracts onboarding information from a pre-existing secondary profile associated with the athlete, such as a profile page from another application, by parsing the secondary profile and including the parsed information with the onboarding information.

The recruiting platform generates an athlete profile as a structured dataset (Operation 306). In one or more implementations, the athlete profile includes structured fields derived from the onboarding information, narrative content, and/or media assets. The athlete profile consolidates information relevant to recruiting into a unified representation suitable for reuse in generating multiple pieces of content over time.

The recruiting platform stores the structured dataset in an athlete profile database (Operation 308). In one or more implementations, the platform uses the athlete profile to facilitate selection of profile information, selection of recruiting targets, generation of targeted communications, and adaptation of recommended actions. Storing the athlete profile facilitates reuse across multiple communication sessions without repeated onboarding and supports consistency of generated communications.

The recruiting platform derives a narrative and/or constraint (Operation 310). In some implementations, the platform derives a narrative that defines messaging characteristics associated with the athlete, such as what profile information is included in generated content, or what tone is used for generated structured text. For example, a constraint regulates generation of communications by controlling prompt structure, by enforcing an inclusionary field and/or an exclusionary field, and/or by enforcing a similarity threshold between communications and/or between a communication and an athlete profile. Such constraints promote consistency and targeting for generated content.

The recruiting platform stores one or more recruiting target profiles as structured datasets (Operation 312). For example, the recruiting target profiles are stored in a recruiting target profile database that includes attributes associated with schools, programs, teams, coaches, and/or other target entities. The recruiting platform retrieves recruiting target information by accessing the one or more recruiting target profiles from the recruiting target profile database. The recruiting platform may also retrieve information by accessing external data sources.

The recruiting platform accesses a user selection of one or more recruiting targets and/or recruiting target attributes (Operation 314). In one or more implementations, the recruiting platform receives, via the website or application, a user-selected target or target attribute specifying one or more criterion, such as a target coach, school, division, geographic region, or other criterion. The recruiting platform uses an AI agent to identify one or more recruiting targets for targeted communication based on the athlete profile, the user selection(s), and the recruiting target profiles.

For example, the recruiting platform uses an AI agent (e.g., a language model) that includes a conversational interface to perform contextual matching by using athlete academic credentials (such as standardized test scores and/or GPA), athletic profile (e.g., sport, gender, position), geographic preferences, and/or athletic division (i.e., D1, D1-AA, D2, D3, JUCO, NAIA), to recommend matching institutions [e.g., members of the national collegiate athletic association (NCAA)]. In some implementations, the AI agent maintains context across multiple conversations between the user and the AI agent via session identifiers. The context is used to exclude previously recommended schools and facilitate iterative refinement of recommendations over multiple recommendations output by the AI agent during multiple different conversations.

The recruiting platform accesses a user selection of at least one profile item or category (Operation 318). For example, the user selects one or more categories or items from the athlete profile. The recruiting platform uses the selected profile item or category to determine a subset of the athlete profile to use for generating a targeted communication or other content.

For example, the platform performs a multi-dimensional search for teams in the recruiting target database based on the user selection(s) by retrieving coaching staff information (e.g., position titles, contact emails, and social media handles) in real time using a Lambda-backed API endpoint. Some implementations use an intelligent name-based search that uses a best match based on a name or specified attributes (e.g., sport or division) when a state or other attribute of a recruiting target is unspecified.

The recruiting platform generates content including structured text (Operation 320). In one or more implementations, the recruiting platform generates content by providing input to a generative model (e.g., an LLM). For example, the platform provides at least a subset of the structured athlete profile, which may have been selected automatically or by the user, recruiting target information, and a prompt into a generative model to cause the model to generate structured text and/or other content. The generative model generates personalized structured email body text and/or structured text for a social media post by using data, such as accomplishments, metrics, highlight links, and/or information about the athlete's references, from an athlete's radar page. In some implementations, the generated content includes formatted hypertext markup language (HTML) content and/or embedded tracking pixels.

For example, when an athlete initiates outreach to a coach, implementations of the recruiting platform automatically generate a professionally formatted HTML email that includes one or more of: (i) a personalized greeting with coach name; (ii) an athlete introduction with position, school, and graduation year; (iii) a filtered accomplishments list excluding blank entries; (iv) a motivational quote or advice block; (v) an academic credentials section; (vi) an athletic metrics table; (vii) one or more hyperlinked highlight resources (YouTube, Hudl, Instagram), optionally wrapped with tracking redirect uniform resource locators (URLs); (viii) one or more news article links; (ix) a contact information block; (x) head coach and reference information; (xi) a profile image, which may be embedded in the email; and/or (xii) a radar page link. In some implementations hyperlinks included in the email route through a Lambda Function URL that captures the destination, athlete email, coach name, coach email, and/or university before redirecting to facilitate comprehensive engagement tracking without requiring functionality from third-party email clients.

Some implementations also input one or more applicable constraints into the model to cause the model to generate output subject to the constraint(s). One or more constraints or other generation parameters may be applied to regulate characteristics of the output, such as content, tone, structure, or format. In some implementations, the generative model uses exclusion logic to exclude (e.g., not generate content for) certain potential recruiting targets for which the corresponding recruiting target profile is incomplete and/or missing data.

Some implementations use the generative model to draft and/or save templates for emails, social media posts, or parts thereof, and to save the templates for reuse. The generative model may store user search and email introduction template preferences across sessions and/or may include automatic validation and stale-data detection. One or more implementations use an AI agent to handle multi-modal response generation by one or more generative models. For example, the AI agent sanitizes (e.g., formats) JavaScript object notation (JSON) responses or other output from the generative model(s) to generate natural language text from other types of output. In some implementations, the AI agent exhibits a preference for using information from structured fields (e.g., answer_summary) while using other fields as fallbacks for the information.

The recruiting platform assigns a task to the user (Operation 322). In one or more implementations, the recruiting platform assigns the communication through a task-based workflow in the application to solicit user review, approval, and/or editing prior to transmission or publication. One or more implementations populate an actionable recommendation card for a task for the athlete that is displayed to the athlete in a graphical user interface of the application. In some implementations, the recruiting platform tracks task progression and uses the task progression as part of a calculation for a rating of the athlete's progress (e.g., a “narrative score”).

The recruiting platform transmits the content via a native application of the client device (Operation 324). In some implementations, the recruiting platform uses a native operating system on the user device to open an email application separate from the recruiting platform application to send an email including structured text. The recruiting application creates a subject field text, a body text, a “to” field text and/or a “from” field text and transfers the text(s) to the native email application so that the content is transmitted to the recruiting target from a personal email account of the athlete. The recruiting platform includes a hyperlink or other tracking artifact in structured text included in the body text of the email to enable tracking of interaction with the email by a recruiting target.

In other implementations, the recruiting platform uses a native social media application, separate from the recruiting platform application, to post content including structured text having a tracking artifact.

The recruiting platform receives interaction metadata associated with the content (Operation 326). In one or more implementations, the recruiting platform receives, from a tracking server, a machine-detectable interaction metric describing interaction with the tracking artifact. For example, a tracking hyperlink is included in structured text sent via email to a recruiting target. Interaction metadata for the email may include a hyperlink activation event, a click event, a click timestamp, a hyperlink URL, a geographic location, or another trackable interaction with the email. In an implementation, a tracking hyperlink included in an email is formatted and/or encoded to prevent the email from being filtered as spam when received by a recruiting target.

The platform uses tracking hyperlinks (or other tracking artifacts) to record sent emails on a per coach, per school, and/or timestamp basis, to record clicks on a per-coach and/or per-university link click events, and/or to record derived statistics such as response rates (e.g., rates of numbers of link clicks per sent email). One or more implementations integrate a tracking pixel into email content to monitor link clicks. Tracking pixel integration facilitates storage of interaction data and/or metadata, which may include coach name, email, timestamp, and/or destination URL.

The interaction metadata is stored in persistent data storage in association with the content, recruiting target, and/or athlete. Information about the interactions is presented to the athlete as analytics and/or is used to guide recommended actions or subsequent content generated by the AI module. The data and/or metadata is logged by the platform, and a visualization of engagement analytics based on the interaction data is accessible via the athlete's profile. For example, the logged data, metadata, and/or derived data is presented to the athlete in an engagement analytics dashboard that presents information such as sent email counts, click metrics, and/or coach engagement level. A user may apply filters to the dashboard to configure the time period window (e.g., weekly, monthly, lifetime, or a custom time window) or to select schools and/or regions to control what tracked interaction data is presented in the dashboard.

The recruiting platform provides at least the interaction metadata and the athlete profile to an AI agent (Operation 328). In one or more implementations, the platform provides the interaction metadata and the athlete profile to the AI agent to cause the AI agent to generate a recommended action that is presented in the user application. For example, the platform provides interaction metadata, such as whether a link in an email sent from the athlete's email address to a recruiting target was clicked on, along with the athlete's profile, as input to a recommendation model (or other AI agent) that is configured to recommend one or more subsequent actions to the athlete. The recommendation model generates, based on the input, a recommendation such as a recommended recruiting target and/or structured text for inclusion in a subsequent email to a same and/or a different recruiting target.

The recruiting platform outputs a recommended action to the client device (Operation 330). An AI agent generates the recommended action by evaluating the interaction metadata for a communication from an athlete to a recruiting target in view of the athlete's profile and the recruiting target's profile. For example, the AI agent generates a recommended action indicating that the user should or should not send a follow-up email to the same recruiting target and/or that the user should send an email with different content. In one or more implementations, the recruiting platform outputs the recommended action over a network connection. The recommended action is displayed as a notification, prompt, or task suggestion within the application. For example, the recruiting platform displays a message or prompt advising the user to follow up with a particular coach within a specified time window and/or a message or prompt advising the user to target a different recruiting target based on the interaction metadata. In this way, the platform adapts subsequent generation of content without requiring a new model to be trained.

For example, the generative AI module generates a subsequent recommendation of a recruiting target by using filtering and/or a weighted scoring history based on engagement data determined from interaction data or metadata recorded for prior outreach. The AI module selects the one or more recruiting targets and generates one or more respective structured text bodies for email(s) targeting the recruiting target(s) based on division fit, coach attributes, geographic proximity, athlete profile strength, and/or other attributes of the athlete or recruiting target.

In some implementations, the platform generates a subsequent communication that is targeted to one or more recruiting targets while excluding one or more other recruiting targets from being targeted based on engagement data indicating that the other recruiting targets have already been contacted and/or suggested by the AI module. The subsequent communication is more likely to be effective in getting a positive response due to the selection of the recruiting target and/or the content being generated based on the prior interaction metadata.

The recruiting platform displays a narrative score (Operation 332). In some implementations, the platform calculates a composite “athlete narrative score” based at least in part on four weighted components: (i) a radar page completion score; (ii) a social connection score (related to use of linked platforms); (iii) a posting frequency score (related to a number of posts per time window); and (iv) a consistency score (unique active days per time window). These components contribute to a curved aggregate that maps to a letter grade (e.g., A through F), that is visible to the athlete in the application. The athlete narrative score rates the athlete's engagement and provides motivation for continued or increased platform engagement.

### 4. Example Recruiting Platform With Generative Profile Creation and Automated Communication

In an example implementation, the recruiting and content generation platform implements a process for generating AI-assisted content, such as emails or social media posts, using information provided by a user. A user accesses the platform through a website or application and completes a signup process. During onboarding, the user completes a questionnaire, which may optionally be AI-monitored, that collects structured and unstructured information, including athlete contact information, additional data points used for internal processing and narrative purposes, and information used to identify a narrative and/or archetype associated with the athlete.

The onboarding information is transmitted to a database and stored as a structured data profile, such as a schema or spreadsheet. In one implementation, collected athlete information and/or archetype data are forwarded to a CRM system, which uses the collected data to construct a prompt for a large language model (LLM). The LLM generates unique content for the athlete using a defined prompt format, and the generated content is associated with a task assignment in the CRM. In an example implementation, profile data is structured, schema-based data that is stored as a typed profile record with explicit fields including contact info, athletic stats, academics, links, outreach history, preferences, and so forth. The profile records are serialized and persisted in a database. Using the database, a profile for a user is rehydrated (e.g., populated by the stored data) into the application when the user logs on. Using a structured schema instead of raw, freeform data or raw JSON blobs improves latency and quality of matching the profile to recruiting targets and of generating content using the profile.

In some implementations, a platform client stores and caches an athlete profile state and/or a recommendation state corresponding to what previous recommendations have been made to the athlete by the platform. The platform uses one or more databases to persist data across devices. Recommendations may be rate-limited with an optional cooldown time to reduce noise and avoid overload.

In some implementations, recommendations are assigned as tasks that are synchronized to a user application, where generated content is updated on a recurring basis. The user may review, edit, and approve the content prior to publication. The platform monitors generated and edited content to reduce duplicative messaging and to detect deviations from the athlete's narrative and warn the user.

In some implementations, the platform uses a mobile-first architecture using React Native with Expo software development kit (SDK), backed by one or more of: (a) State Management: a MobX-State-Tree reactive state that stores with persistent local caching via Amazon Web Services (AWS) Dynamo database (DynamoDB); (b) CRM Integration: a GoHighLevel API integration for contact management, task assignment, and custom field synchronization; (c) a Serverless Backend: AWS Lambda Function URLs for school/coach data retrieval, AI counselor recommendations, email tracking, and stats reporting; (d) Social Analytics: SocialBlade API integration for real-time Twitter, Instagram, and TikTok follower/engagement metrics; (e) Subscription Management: RevenueCat integration for iOS/Android in-app purchase management with tiered access controls; and/or (f) White-Label Support: Affiliate customization system with dynamic theming (colors, logos) loaded from DynamoDB based on affiliate identifier. For example, one or more implementations persist data using AWS DynamoDB with separate tables for athlete contacts (e.g., athletenarrative), post history (e.g., posthistory), user activity tracking (e.g., usertrack), and affiliate customizations (an-affiliate-customizations). Such implementations use secondary indexes (e.g., EmailIndex) for efficient queries and use AWS SDK with programmatic access credentials.

### 5. Example Graphical User Interfaces

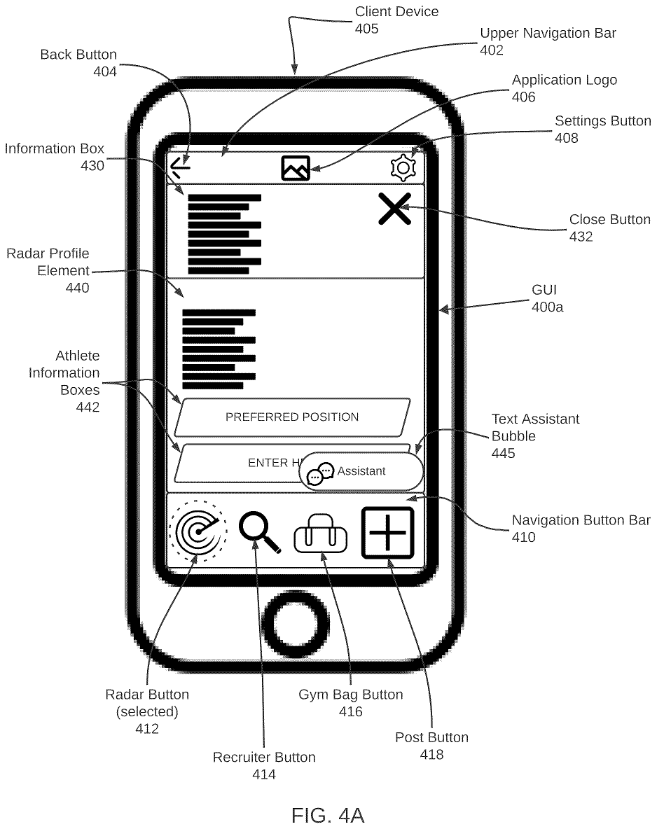

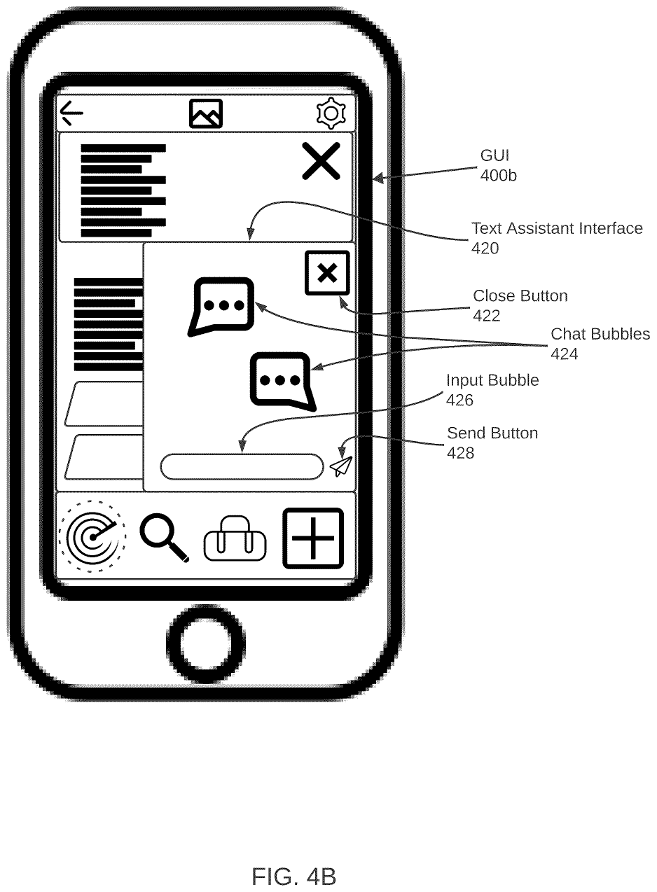

FIGS. 4A-7 illustrate graphical user interfaces (GUIs) associated with a recruiting platform application. The GUIs may be implemented via a web application, a desktop application, or a mobile application, such as application 220.

In some implementations, graphical features of the GUIs are defined according to branding metadata so that the visual appearance of the application changes depending on associations with different brands. The visual appearance of the application is changeable based on the metadata to reflect color schemes, logos, or other branding elements associated with the different brands. This facilitates the application operating as a “gray label” application in which the color schemes and logos change based on different branding, so that multiple partners may host different versions of the application that match the branding of the multiple partners. The application uses the branding metadata to define one or more colors, logos, fonts, or other visual elements presented in the GUIs to align with the different partners'branding.

FIG. 4A illustrates a GUI 400a for profile module, according to one or more implementations. The GUI 400a includes a radar page configured to present and manage a structured athlete profile associated with a user. In FIG. 4A, a client device 405 is illustrated as a mobile device, such as a smartphone. However, in other implementations, the GUI 400a may be presented on a display of a laptop computer, a desktop computer, a tablet, or another computing device. As illustrated, the GUI 400a includes an upper navigation bar 402, a navigation button bar 410, an information box 430, a radar page element 440, and a text assistant bubble 445.

As shown, the upper navigation bar 402 includes a back button 404, an application logo 406, and a settings button 408. The back button 404 is interactable to allow the user to navigate to a previously displayed GUI or a previous application state. The application logo 406 visually displays a design element associated with the application and, in some implementations, may include one or more logos associated with sponsors of the athlete or with a particular brand. For example, the appearance of the application logo 406 is defined according to branding metadata for a partner or sponsor. The settings button 408 is interactable to present configuration options, preferences, account settings, or other administrative controls associated with the user account.

In the example of FIG. 4A, the navigation button bar 410 includes a radar button 412, a recruiter button 414, a gym bag button 416, and a post button 418. In the illustrated example, the radar button 412 is highlighted or otherwise visually distinguished to indicate that the GUI 400a corresponds to the radar module. The radar button 412, recruiter button 414, gym bag button 416, and post button 418 are interactable to allow a user to navigate to different functional portions of the application. Upon interaction with one of the buttons, the application transitions to a corresponding GUI associated with the selected function and highlights or otherwise indicates the selected button.

As illustrated in FIG. 4A, the information box 430 includes textual information and a close button 432 used to close the information box 430. In one or more implementations, the information box 430 presents instructional text, guidance, alerts, and/or the like. Interaction with the close button 432 hides the information box 430.

In FIG. 4A, the radar page element 440 includes athlete information boxes 442 that are configured to receive information from a user. The athlete information boxes 442 correspond to fields of the structured athlete profile, such as personal attributes, athletic attributes, academic attributes, preferences, or other profile-related data. User input entered into the athlete information boxes 442 is stored in the structured athlete profile in persistent storage. As shown, a text assistant bubble 445 is overlaid over a portion of the radar page element 440. The text assistant bubble 445 is interactable to cause the GUI 400a to expand into a chat interface that enables conversational interaction between the user and the text assistant. In one or more implementations, a user may scroll up or down to display different portions of the GUI 400a. For example, a user may scroll downward to reveal additional athlete information boxes 442.

FIG. 4B illustrates a GUI 400b for the profile module with a text assistant interface 420 that has been opened by a user interacting with the text assistant bubble 445. In FIG. 4B, the text assistant interface 420 includes a close button 422, chat bubbles 424, an input bubble 426, and a send button 428.

The close button 422 is interactable to allow a user to close the text assistant interface 420 and return to the underlying radar page. In one or more implementations, interaction with the close button 422 hides the text assistant interface 420. The chat bubbles 424 present messages exchanged between the user and the text assistant. The assistant-generated messages may include guidance, suggestions, clarifying questions, or confirmations related to information entered into the radar page element 440. The input bubble 426 allows the user to provide input into the text assistant to ask questions, provide responses, and/or provide information. Text entered into the input bubble 426 may be used by the text assistant to update one or more fields of the structured athlete profile. The send button 428 is configured to transmit textual input from the user to the text assistant in response to being clicked or tapped by the user.

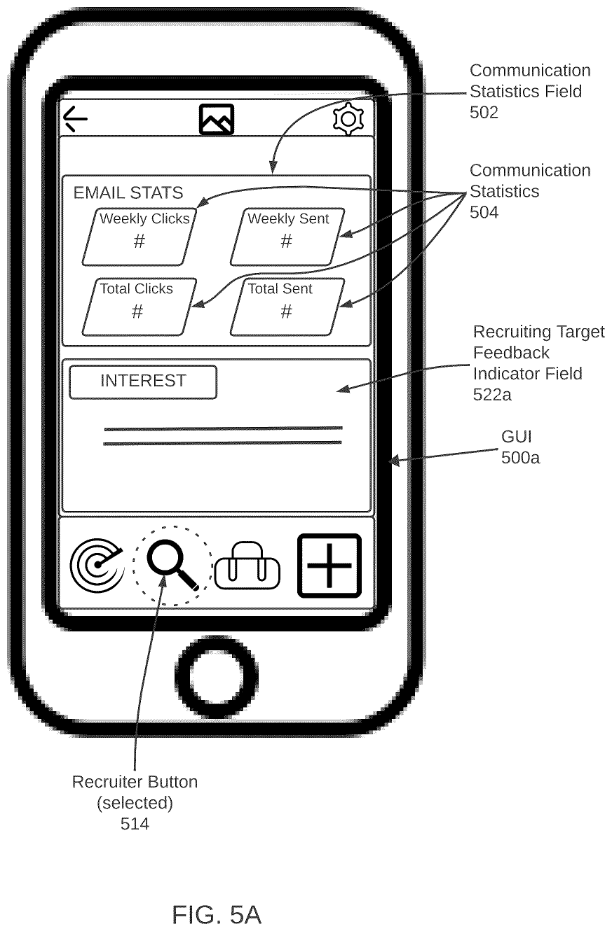

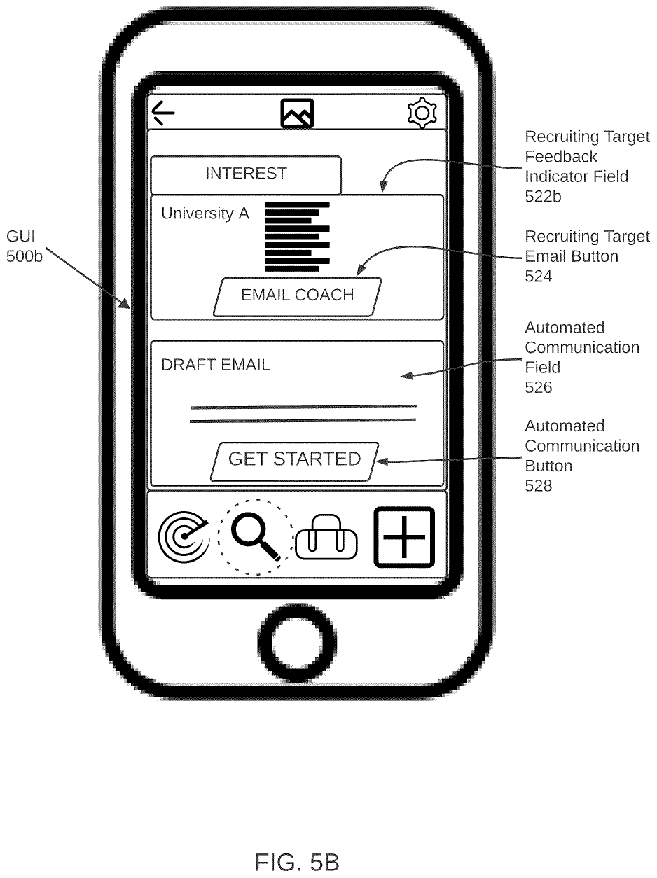

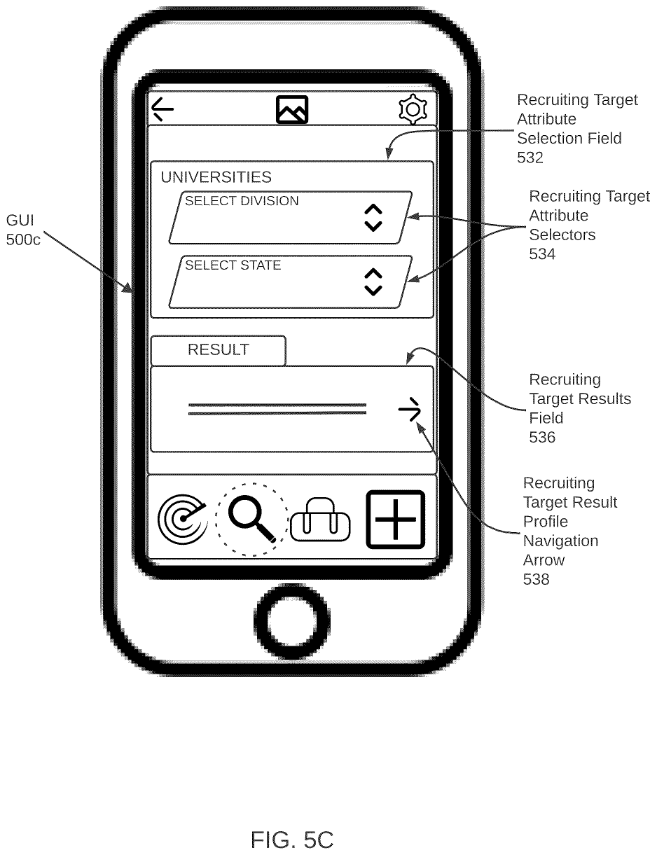

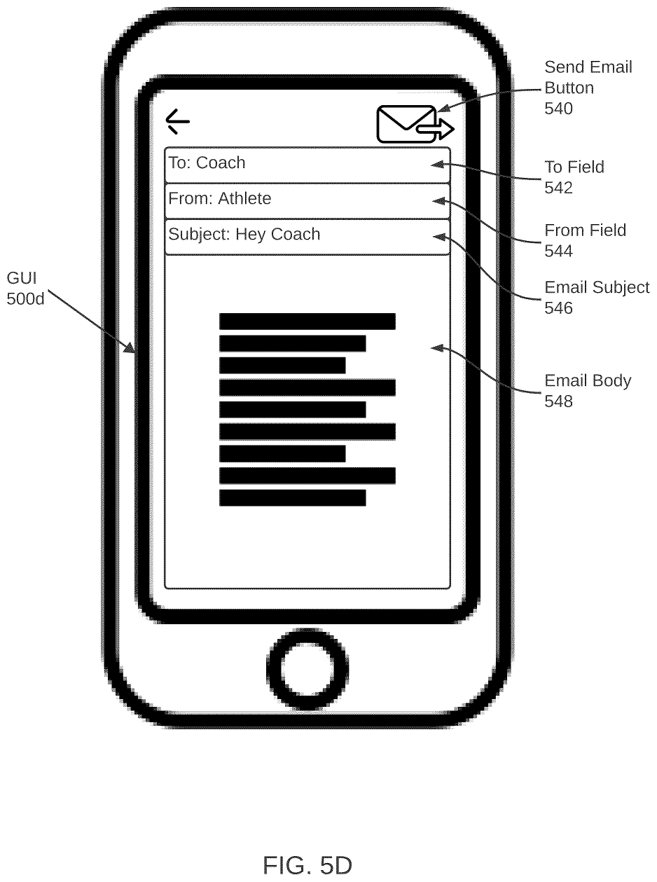

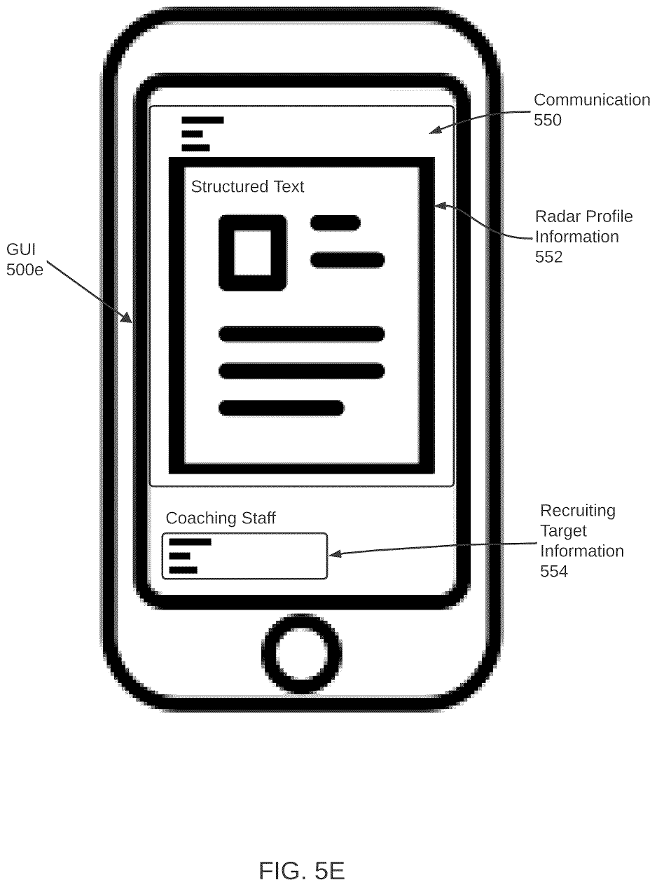

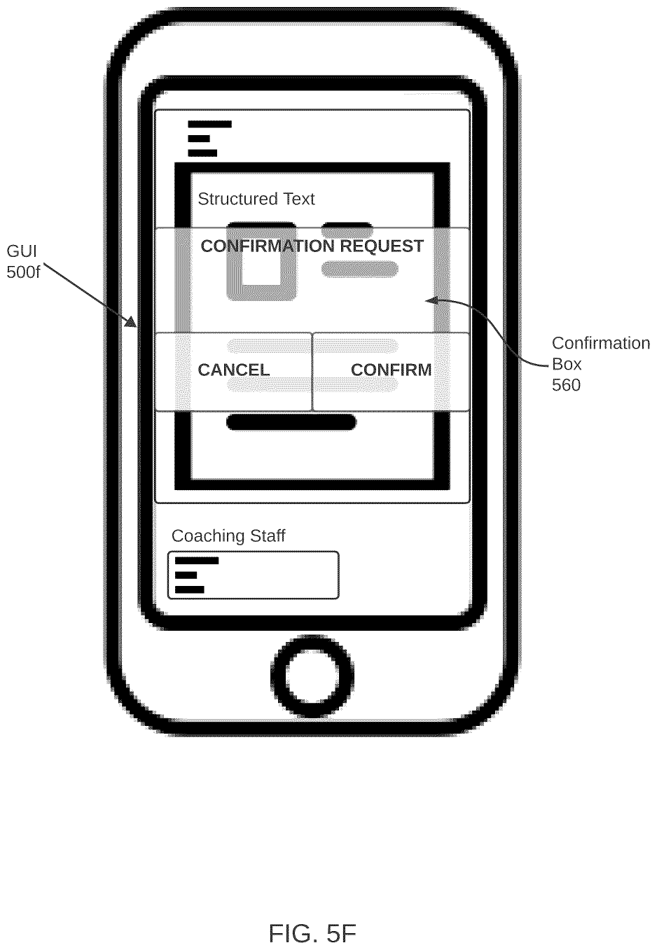

FIG. 5A illustrates a GUI 500a associated with a recruiter module. The GUI 500a presents feedback and/or interaction metadata related to previous communications. As shown, the GUI 500a includes a communication statistics field 502, communication statistics 504, and a recruiting target feedback indicator field 522a. In FIG. 5A, a recruiter button 514 is highlighted or otherwise visually indicated as selected to denote GUI 500a is part of the recruiter module.

The communication statistics field 502 defines a region of the GUI 500a that presents information related to communications generated and/or transmitted by the recruiting platform. The communication statistics field 502 displays interaction metadata and/or other metrics. The communication statistics 504 include one or more quantitative or categorical metrics associated with transmitted communications. The communication statistics 504 may include, for example, a number of communications sent, a number of target entities contacted, response rates, click rates, or other interaction metadata. In some implementations, the communication statistics 504 are updated dynamically based on target interaction with an embedded tracking artifact or by output from an executable script contained in a communication. The recruiting target feedback indicator field 522a is configured to visually present interaction metadata and/or other feedback received from one or more target entities. In one or more implementations, the recruiting target feedback indicator field 522a displays indicators for individual recruiting targets or emails, such as whether an email has been interacted with and/or indicators that are aggregated for multiple recruiting targets and/or multiple emails.

FIG. 5B illustrates a GUI 500b that is also associated with the recruiter module. The GUI 500b presents controls and information related to initiating and/or managing communications (e.g., email) with recruiting targets. As shown, the GUI 500b includes a recruiting target feedback indicator field 522b, a recruiting target email button 524, an automated communication field 526, and an automated communication button 528.

The recruiting target feedback indicator field 522b presents feedback indicators associated with a particular recruiting target. The recruiting target feedback indicator field 522b reflects communication states such as pending or delivered. The recruiting target email button 524 is interactable to initiate an email communication with a recruiting target. Interaction with the recruiting target email button 524 causes the recruiting platform to generate or retrieve structured text, open a native email client, and/or include the structured text in a field of an email. The automated communication field 526 presents information describing automated communication generated by the recruiting platform. In one or more implementations, the automated communication field 526 displays a structured text generated by the generative AI module based on the user's athlete profile and the recruiting target attributes. The automated communication button 528 is interactable to trigger automated generation or initiation of a communication. For example, interaction with the automated communication button 528 causes the recruiting platform to generate a targeted email.

FIG. 5C illustrates a GUI 500c that is also associated with the recruiter module. The GUI 500c supports selection and filtering of recruiting targets based on user-selected attributes. As shown, the GUI 500c includes a recruiting target attribute selection field 532, recruiting target attribute selectors 534, a recruiting target results field 536, and a recruiting target result profile navigation arrow 538.

The recruiting target attribute selection field 532 defines a region of the GUI 500c that provides filtering controls for identifying candidate recruiting targets based on attributes. The recruiting target attribute selection field 532 allows a user to specify criteria such as athletic division, geographic region, institution type, or other attributes that guide target selection. The recruiting target attribute selectors 534 include one or more interactable controls, such as dropdowns, toggles, or selectable list items, that allow the user to select or modify target attributes. The recruiting platform uses these selections to determine and/or rank recruiting targets. The recruiting target results field 536 presents a set of recruiting target results that satisfy the selected recruiting target attributes. The recruiting target results field 536 displays candidate schools, programs, coaches, or other entities, along with information about the entities. The recruiting target result profile navigation arrow 538 is interactable to allow the user to navigate to a detailed profile view associated with a selected recruiting target.

FIG. 5D illustrates a GUI 500d that is associated with a communication module. The GUI 500d presents an interface for reviewing and transmitting an electronic communication. As shown, the GUI 500d includes a send email button 540, a to field 542, a from field 544, an email subject 546, and an email body 548.

The send email button 540 is interactable to transmit the displayed email communication. In one or more implementations, interaction with the send email button 540 initiates transmission of the email via a native email client or other communication channel. The to field 542 displays recipient information. The to field 542 is populated with an email address of a selected recruiting target. The from field 544 displays sender information associated with the user. The from field 544 contains the personal email address of the user and is populated based on the user's account settings. The email subject 546 presents a subject line generated or suggested by the recruiting platform. The email subject 546 is generated by the generative AI module based on the athlete profile and recruiting target attributes. The email body 548 presents the content of the email communication. The email body 548 includes text generated by the generative AI module and may incorporate information derived from the athlete profile and the selected recruiting target. The user may review and edit the email body 548 prior to sending.

FIG. 5E illustrates a GUI 500e that is also associated with the communication module. The GUI 500e includes a communication 550, radar page information 552, and recruiting target information 554. The communication 550 includes a draft of structured text targeted to the recruiting target that is generated by the generative AI module and presented for user review, editing, or approval. The radar page information 552 presents selected information from the athlete's radar page. The recruiting target information 554 presents information associated with the selected recruiting target.

FIG. 5F illustrates a GUI 500f that is also associated with the communication module. The GUI 500f is similar to the GUI 500e, except that the GUI 500f includes a confirmation box 560 overlaid over the structured text or another portion of the GUI 500f. The confirmation box 560 presents options allowing the user to confirm or cancel transmission of the communication. Responsive to the user confirming, the recruiting platform transmits the communication. Responsive to the user cancelling, the application returns to the GUI 500e without transmitting the communication.

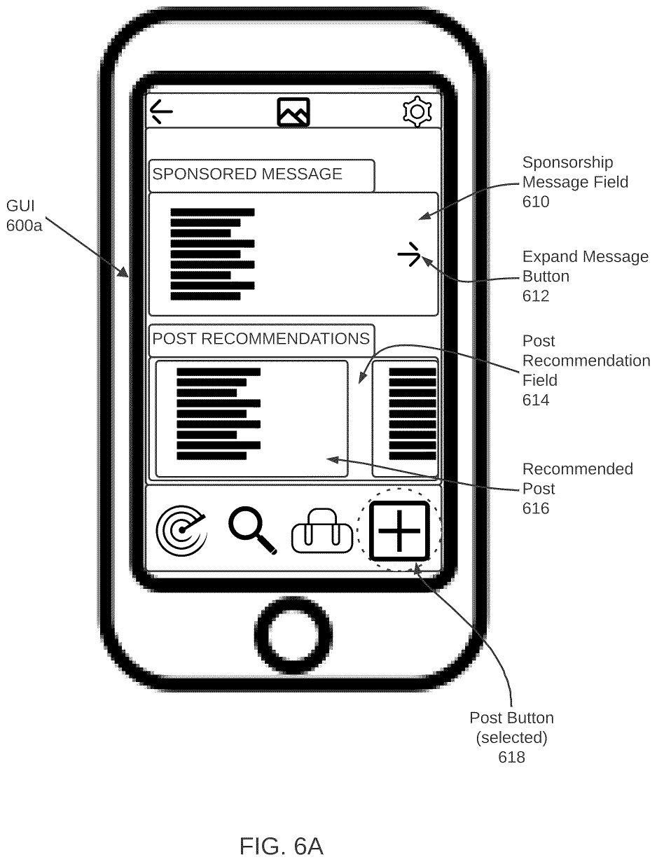

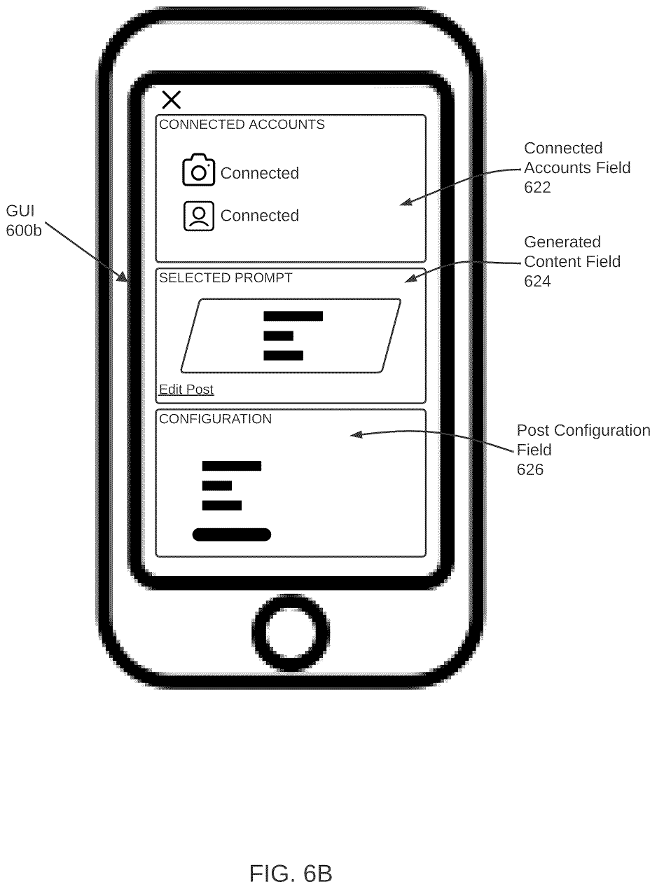

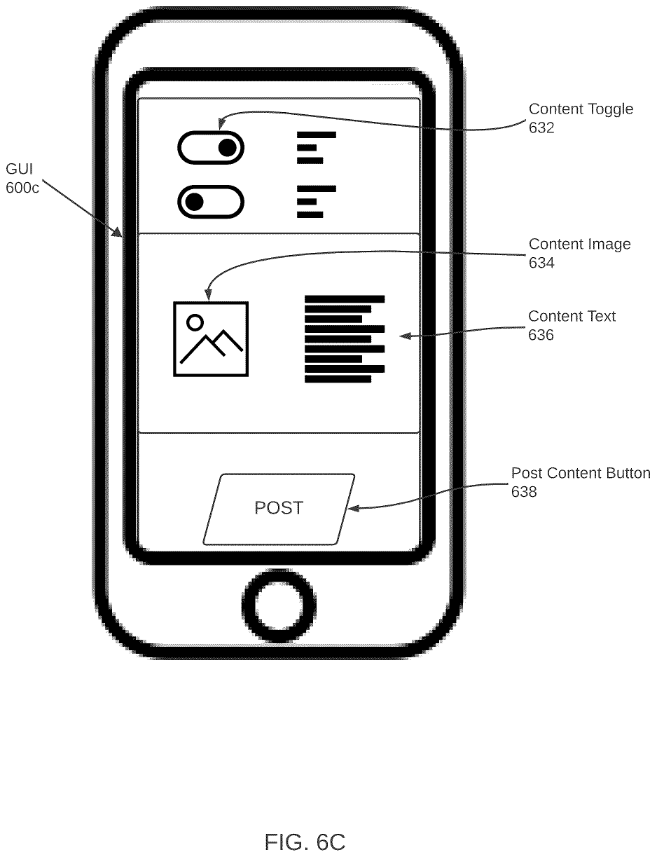

FIG. 6A illustrates a GUI 600a associated with a content module. The GUI 600a presents content recommendations and generated content for potential publication via social media. In FIG. 6A, a post button 618 is highlighted or otherwise visually indicated as selected to denote that the content module is active. As shown, the GUI 600a includes a sponsorship message field 610, an expand message button 612, a post recommendation field 614, and a recommended post 616.

The sponsorship message field 610 defines a region of the GUI 600a that is configured to present a generated sponsored message. In one or more implementations, the sponsorship message field 610 displays text generated by the generative AI module based on the athlete profile, narrative constraints, and/or social framework data. The expand message button 612 is interactable to expand or otherwise reveal additional content associated with the sponsorship message field 610. Interaction with the expand message button 612 causes the GUI to display a larger view of the sponsored message, additional context, or editing options related to the message. The post recommendation field 614 presents a recommended post item. The post recommendation field 614 includes content that is aligned with the athlete's narrative. The recommended post 616 includes structured text contained in the post recommendation field 614. Interaction with the recommended post 616 facilitates reviewing, editing, or publishing the selected content.

FIG. 6B illustrates a GUI 600b that is also associated with the content module. The GUI 600b presents an interface for reviewing and configuring a selected content item prior to publication. As shown, the GUI 600b includes a connected accounts field 622, a generated content field 624, and a post configuration field 626. The connected accounts field 622 presents one or more of the athlete's connected external accounts (e.g., social media accounts). The connected accounts field 622 indicates which social media or content platforms are linked to the athlete's user account that are available as publication destinations for the generated content. The generated content field 624 presents generated content, which may be associated with a selected content prompt, and which may be reviewed or edited prior to publication. The post configuration field 626 presents configuration options associated with publishing the generated content. The post configuration field 626 allows the user to adjust parameters such as platform selection, formatting options, timing, or other settings.

FIG. 6C illustrates a GUI 600c that is also associated with the content module. As shown, the GUI 600c includes a content toggle 632, a content image 634, content text 636, and a post content button 638. The content toggle 632 is interactable to enable or disable one or more content elements associated with the post. In one or more implementations, the content toggle 632 allows the user to selectively include or exclude content components. The content image 634 presents an image included with the post. The content image 634 may be automatically selected by the recruiting platform, uploaded or otherwise selected by the athlete. The content text 636 presents text included in the post. In one or more implementations, the content text 636 includes structured text generated by the generative AI module that may be edited by the user prior to publication. The post content button 638 is interactable to initiate transmission and/or publication (and/or confirmation) of the post.

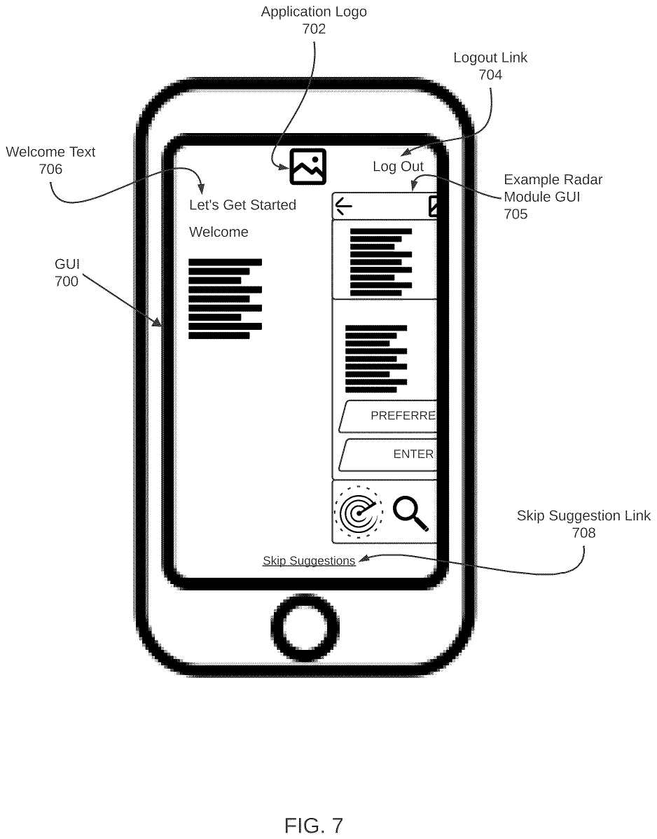

FIG. 7 illustrates a GUI 700 associated with an onboarding and introductory workflow. The GUI 700 presents an initial interface to a user upon first accessing the application. As shown, the GUI 700 includes an application logo 702, a logout link 704, welcome text 706, a skip suggestion link 708, and an example radar module GUI 705.

The application logo 702 visually identifies the application. In one or more implementations, the application logo 702 is displayed in a persistent header region of the GUI. The logout link 704 is interactable to terminate the current user session. The welcome text 706 presents introductory information to the user. In one or more implementations, the welcome text 706 provides instructional or contextual guidance, next steps in the onboarding process, or suggested actions to begin using the platform. The skip suggestion link 708 is interactable to allow the user to bypass suggested onboarding steps or guidance. Interaction with the skip suggestion link 708 causes the application to proceed to a subsequent interface, such as a radar page GUI or recruiter module GUI, without requiring completion of onboarding actions. The example radar module GUI 705 presents a preview or example of a radar page interface.

### 6. Hardware Overview

Embodiments of the above-described system may be implemented in a computing environment including a network, a backend server that facilitates functions of the content generation platform and a plurality of client devices that execute an application that interacts with the backend server to enable the user experience described herein. Other embodiments may include additional or different components.

The network enables communication among the entities connected to it through one or more local-area networks and/or wide-area networks. In one embodiment, the network includes the Internet and uses standard wired and/or wireless communications technologies and/or protocols or may use custom and/or dedicated data communications technologies instead of, or in addition to, the ones described above.

The backend server includes a computing device for facilitating various functions described herein. The backend server may host a website accessible by a browser executing on the clients and/or may include an application server hosting content accessible by applications executing on the clients. The backend server may perform various backend processing to facilitate tasks such as obtaining information, presenting information to the user, and facilitating generation of content via various generative AI techniques (or interfacing with third-party generative AI platforms). The backend server may include an application programming interface (API) that enables it to interface with various third-party databases or servers for storing information described herein.

In one or more implementations, one or more client devices include a computing device that interfaces with the backend server to obtain inputs from users and to receive and display information received from the backend server. A client device may include, for example, a mobile device, a tablet, a laptop computer, a desktop computer, or other computing device capable of communicating and displaying information. The client devices may each execute a browser or an application that interacts with the backend server to facilitate the functions of the respective devices described herein.

Embodiments of the described computing environment and corresponding processes may be implemented by one or more computing systems. The one or more computing systems include at least one processor and a non-transitory computer-readable storage medium storing instructions executable by the at least one processor for carrying out the processes and functions described herein. The computing system may include distributed network-based computing systems in which functions described herein are not necessarily executed on a single physical device. For example, some implementations may utilize cloud processing and storage technologies, virtual machines, or other technologies.

According to one or more examples, some aspects of the techniques described herein are implemented by one or more computing devices (e.g., in implementation of the recruiting platform 210, and/or other hardware). The computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such computing devices may also combine custom hard-wired logic, ASICs, FPGAs, or NPUs with custom programming to accomplish the techniques. In some implementations, the recruiting platform may be coupled to one or more external computing devices that may provide various control or command functions, such as, for example, desktop computer systems, portable computer systems, handheld devices, networking devices, or any other device that incorporates hard-wired and/or program logic to implement the techniques.

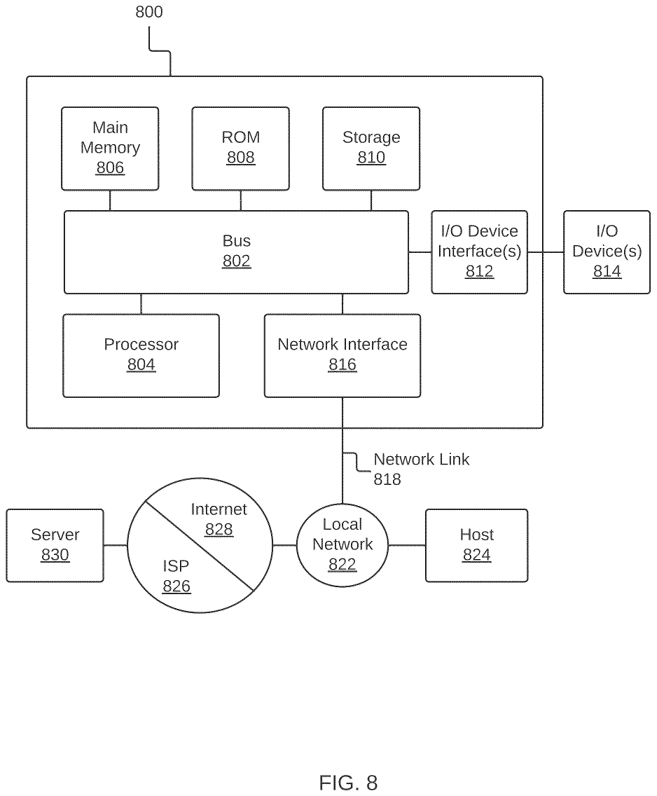

For example, FIG. 8 is a block diagram that illustrates a computer system 800 upon which one or more aspects of the disclosure may be implemented. For example, one or more client devices include one or more aspects of the example computer system 800. In FIG. 8, computer system 800 includes a bus 802 or other communication mechanism for communicating information, and a hardware processor 804 coupled with bus 802 for processing information. Hardware processor 804 may be, for example, a general-purpose microprocessor.

Computer system 800 also includes a main memory 806, such as a random-access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or a Solid-State Drive (SSD) is provided and coupled to bus 802 for storing information and instructions.

In one or more implementations, computer system 800 may be coupled via bus 802 to one or more input and/or output (I/O) device interfaces 812 that allow for the connection of various I/O devices 814 (e.g., keyboards, displays, mouse devices, pen input, etc.) to the computer system 800.

Computer system 800 may implement the techniques described herein using customized hard-wired logic, one or more ASICs or FPGAs, firmware, and/or program logic which in combination with the computer system causes or programs computer system 800 to be a special-purpose machine. According to one implementation, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative implementations, hard-wired circuitry may be used in place of or in combination with software instructions.

Storage media associated with the described system may include any non-transitory media that store data and/or instructions that cause a machine to operate in a specific fashion. Such storage media may include non-volatile media and/or volatile media. Non-volatile media includes, for example, optical or magnetic disks, such as storage device 810. Volatile media includes dynamic memory, such as main memory 806. Common forms of storage media include, for example, a hard disk, solid state drive, optical data storage medium, a random-access memory (RAM), a programmable read-only memory (PROM), and erasable programmable read-only memory (EPROM), a FLASH-EPROM, non-volatile random-access memory (NVRAM), any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire, and fiber optics, including the wires of bus 802. Transmission media can also take the form of acoustic or light waves, such as those generated during radio-wave and infrared data communications.

Various forms of media may be involved in carrying one or more sequences of one or more instructions to processor 804 for execution. For example, the instructions may initially be carried on a storage medium of a remote computer. The remote computer can load the instructions into its dynamic memory and send the instructions over a network. Bus 802 carries the data to main memory 806, from which processor 804 retrieves and executes the instructions. The instructions received by main memory 806 may optionally be stored on storage device 810 either before or after execution by processor 804.

In one or more implementations, computer system 800 also includes a network interface 816 coupled to bus 802. This may enable the described recruiting platform to connect to an external local device (such as a mobile device or personal computer) and/or to one or more remote servers that may support various operations of the described system. Network interface 816 provides a two-way data communication coupling to a network link 818 that is connected to a local network 820. For example, network interface 816 may include a local area network (LAN) interface to provide a data communication connection to a compatible LAN. Wireless links may also be implemented. In implementations, network interface 816 sends and/or receives electrical, electromagnetic, and/or optical signals that carry digital data streams representing various types of information. In one or more implementations the network interface 816 may be used to load configuration parameters and/or to update firmware associated with one or more controllers or microcontrollers deployed by the system.

Network link 818 typically provides data communication through one or more networks to other data devices. For example, network link 818 may provide a connection through local network 822 to a host computer 824 or to data equipment operated by an Internet Service Provider (ISP) 826. ISP 826 in turn provides data communication services through the worldwide packet data communication network (e.g., the Internet) 828. Local network 822 and/or Internet 828 use electrical, electromagnetic, and/or optical signals that carry digital data streams. The signals through various networks and the signals on network link 818 and through network interface 816, which carry the digital data to and from computer system 800, are example forms of transmission media.

Computer system 800 can send messages and receive data, including program code, through the network(s), network link 818 and network interface 816. In the Internet example, a server 830 might transmit a requested code for an application program through Internet 828, ISP 826, local network 822 and network interface 816. The received code may be executed by processor 804 as it is received, and/or stored in storage device 810, or other non-volatile storage for later execution.

### 7. Miscellaneous; Extensions

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information, or as modules for executing these operations. Embodiments may also include methods in which steps may be performed in different order than in the example embodiments described and/or illustrated in the figures. Any of the methods described herein may be implemented as a computer program including instructions stored in a tangible non-transitory computer readable storage medium. These instructions may be executed by one or more processors to carry out the functions described.

Embodiments may also relate to an apparatus for performing the operations herein. This apparatus may be specially constructed for the required purposes, and/or it may include a general-purpose computing device selectively activated or reconfigured by a computer program stored in the computer. Furthermore, any computing systems referred to in the specification may include a single processor or may include architectures employing multiple processor designs for increased computing capability. Examples of hardware that may be utilized in executing the described operations may include a general purpose processor (CPU), a graphics processing unit (GPU), a neural processing unit (NPU), a field-programmable gate array (FPGA), an application-specific integrated circuit (ASIC), a microcontroller, or other hardware or combination thereof.

In embodiments where the described device is network-enabled, the device may connect to one or more local devices that execute a user application (such as a mobile device or personal computer), and/or may connect directly or indirectly to one or more remote servers via a network. Operations supporting the connected devices or servers may utilize on-site computing or storage systems, cloud computing or storage systems, or a combination thereof and may be implemented utilizing local or cloud-based servers, which may include physical or virtual machines, containers, or a combination thereof. Cloud-based servers may include private cloud systems, public cloud systems, hybrid public/private cloud systems, or a combination thereof.

The language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Persons skilled in the relevant art can appreciate that many modifications and variations are possible considering the above disclosure. Accordingly, the disclosure of the embodiments is intended to be illustrative, but not limiting, of the scope of the patent rights, which is set forth in the following claims.

What is claimed is:

1. One or more non-transitory computer readable media comprising instructions which, when executed by one or more hardware processors, cause performance of operations comprising:
storing an athlete profile for a user as a structured dataset in an athlete profile database;
storing a set of recruiting target profiles for a set of recruiting targets as structured datasets in a recruiting target profile database;
receiving, over a network, from a user application executing on a client device, a selection of (i) at least one of a recruiting target or a recruiting target attribute and (ii) at least one profile category including profile information to be shared with a recruiting target of the set of recruiting targets;
providing, as input data to a language model, (i) at least a subset of the athlete profile selected based on the at least one profile category, (ii) at least a subset of a recruiting target profile for a recruiting target of the set of recruiting targets, and (iii) a language model prompt that causes the language model to generate structured text targeted to the recruiting target, wherein the structured text includes a hyperlink that enables trackable interactions;
causing a native email application of the client device, separate from the user application, to generate an email message including the structured text;
receiving, from a tracking server, interaction metadata describing an interaction with the hyperlink;
providing at least the interaction metadata and the athlete profile to an artificial intelligence (AI) agent configured to generate a recommended action for presentation in the user application; and
outputting, over the network to the client device, the recommended action.

2. The non-transitory computer readable media of claim 1, wherein the operations further comprise:
deriving a constraint from the athlete profile and the at least one of the recruiting target or the recruiting target attribute; and
providing the constraint as a control input to the language model to generate the structured text subject to the constraint.

3. The non-transitory computer readable media of claim 2, wherein:
the constraint comprises at least one of: an inclusionary field that must be included, an exclusionary field that must be excluded, a similarity threshold between the structured text and an athlete profile, or an athlete narrative constraint.

4. The non-transitory computer readable media of claim 1, wherein:
causing the native email application to generate the email message further comprises:
accessing a personal email address of the user; and
invoking the native email application executing on the client device to send the email message from a personal email address of the user.

5. The non-transitory computer readable media of claim 1, wherein:
the athlete profile comprises: an identification of a sport, a video clip or image of the user participating in the sport, a grade point average of the user, and a statistic corresponding to a historical athletic performance of the user in the sport;
the selection of at least one recruiting target attribute comprises at least one of a target athletic division, a target geographic state, or a target school; and
the operations further comprise:
accessing a recruiting target attribute associated with a recruiting target; and
inputting the recruiting target attribute and the athlete profile to the language model to cause the structured text to be targeted to the recruiting target based on a match between the recruiting target attribute and the selection.

6. The non-transitory computer readable media of claim 1, wherein the operations further comprise:
accessing a secondary profile associated with the user;
parsing the secondary profile to extract an attribute associated with the user; and
including the attribute in the athlete profile.

7. The non-transitory computer readable media of claim 1, wherein the operations further comprise:
generating an auxiliary communication, using the language model, to an auxiliary entity distinct from the recruiting target, wherein the auxiliary communication includes at least one of a description of the structured text and a description of the interaction metadata.

8. The non-transitory computer readable media of claim 1, wherein the operations further comprise:
outputting a plurality of email messages including a plurality of respective structured text bodies corresponding to the athlete profile to a plurality of recruiting targets; and
responsive to receiving interaction metadata associated with the plurality of email messages, aggregating the interaction metadata into a graphical user interface accessible by the user.

9. The non-transitory computer readable media of claim 1, wherein the interaction metadata comprises at least one interaction metric selected from:
a click event, a hyperlink activation event, a click timestamp, a URL, or a geographic location.

10. The non-transitory computer readable media of claim 1, wherein the operations further comprise:
assigning the email message as an approvable task within a task-based workflow system accessible by the user, wherein the user application requires approval of the email message prior to transmission.

11. The non-transitory computer readable media of claim 1, further comprising:
providing, as input data to a generative model, (i) the subset of the athlete profile selected based on the at least one profile category and (ii) a generative model prompt that causes the generative model to generate social media content;
detecting feedback associated with the social media content; and
providing at least the feedback to the AI agent to cause the AI agent to generate a subsequent recommendation.

12. The non-transitory computer readable media of claim 1, wherein:
the athlete profile is rendered as a persistent profile page accessible via a network and used as a source for generating the structured text.

13. The non-transitory computer readable media of claim 1, wherein:
receiving the interaction metadata comprises detecting interaction with an embedded tracking artifact included in the structured text, the embedded tracking artifact comprising at least one of: a tracking hyperlink, a tracking pixel, or an executable script configured to generate the interaction metadata.

14. A method, comprising:
storing an athlete profile for a user as a structured dataset in an athlete profile database;
storing a set of recruiting target profiles for a set of recruiting targets as structured datasets in a recruiting target profile database;
receiving, over a network, from a user application executing on a client device, a selection of (i) at least one of a recruiting target or a recruiting target attribute and (ii) at least one profile category including profile information to be shared with a recruiting target of the set of recruiting targets;
providing, as input data to a language model, (i) at least a subset of the athlete profile selected based on the at least one profile category, (ii) at least a subset of a recruiting target profile for a recruiting target of the set of recruiting targets, and (iii) a language model prompt that causes the language model to generate structured text targeted to the recruiting target, wherein the structured text includes a hyperlink that enables trackable interactions;
causing a native email application of the client device, separate from the user application, to generate an email message including the structured text;
receiving, from a tracking server, interaction metadata describing an interaction with the hyperlink;
providing at least the interaction metadata and the athlete profile to an artificial intelligence (AI) agent configured to generate a recommended action for presentation in the user application; and
outputting, over the network to the client device, the recommended action,
wherein the method is performed by at least one device including a hardware processor.

15. The method of claim 14, further comprising:
deriving a constraint from the athlete profile and the at least one of the recruiting target or the recruiting target attribute; and
providing the constraint as a control input to the language model to generate the structured text subject to the constraint,
wherein the constraint comprises at least one of: an inclusionary field that must be included, an exclusionary field that must be excluded, a similarity threshold between the structured text and an athlete profile, or an athlete narrative constraint.

16. The method of claim 14, wherein:
causing the native email application to generate the email message further comprises:
accessing a personal email address of the user; and
invoking the native email application executing on the client device to send the email message from a personal email address of the user.

17. The method of claim 14, wherein:
the athlete profile comprises: an identification of a sport, a video clip or image of the user participating in the sport, a grade point average of the user, and a statistic corresponding to a historical athletic performance of the user in the sport;
the selection of at least one recruiting target attribute comprises at least one of a target athletic division, a target geographic state, or a target school; and
the method further comprises:
accessing a recruiting target attribute associated with a recruiting target; and
inputting the recruiting target attribute and the athlete profile to the language model to cause the structured text to be targeted to the recruiting target based on a match between the recruiting target attribute and the selection.

18. A system, comprising:
one or more hardware processors;
one or more non-transitory computer readable media; and
instructions stored on the one or more non-transitory computer readable media which, when executed by the one or more hardware processors, cause the system to perform operations comprising:
storing an athlete profile for a user as a structured dataset in an athlete profile database;
storing a set of recruiting target profiles for a set of recruiting targets as structured datasets in a recruiting target profile database;
receiving, over a network, from a user application executing on a client device, a selection of (i) at least one of a recruiting target or a recruiting target attribute and (ii) at least one profile category including profile information to be shared with a recruiting target of the set of recruiting targets;
providing, as input data to a language model, (i) at least a subset of the athlete profile selected based on the at least one profile category, (ii) at least a subset of a recruiting target profile for a recruiting target of the set of recruiting targets, and (iii) a language model prompt that causes the language model to generate structured text targeted to the recruiting target, wherein the structured text includes a hyperlink that enables trackable interactions;
causing a native email application of the client device, separate from the user application, to generate an email message including the structured text;
receiving, from a tracking server, interaction metadata describing an interaction with the hyperlink;
providing at least the interaction metadata and the athlete profile to an artificial intelligence (AI) agent configured to generate a recommended action for presentation in the user application; and
outputting, over the network to the client device, the recommended action.

19. The system of claim 18, wherein the operations further comprise:
deriving a constraint from the athlete profile and the at least one of the recruiting target or the recruiting target attribute;
providing the constraint as a control input to the language model to generate the structured text subject to the constraint;
accessing a recruiting target attribute associated with a recruiting target; and
inputting the recruiting target attribute and the athlete profile to the language model to cause the structured text to be targeted to the recruiting target based on a match between the recruiting target attribute and the selection,
wherein the constraint comprises at least one of: an inclusionary field that must be included, an exclusionary field that must be excluded, a similarity threshold between the structured text and an athlete profile, or an athlete narrative constraint;
wherein the athlete profile comprises: an identification of a sport, a video clip or image of the user participating in the sport, a grade point average of the user, and a statistic corresponding to a historical athletic performance of the user in the sport; and
wherein the selection of at least one recruiting target attribute comprises at least one of a target athletic division, a target geographic state, or a target school.

20. The system of claim 18, wherein:
causing the native email application to generate the email message further comprises:
accessing a personal email address of the user; and
invoking the native email application executing on the client device to send the email message from a personal email address of the user.
